(19) United States
(12) Patent Application Publication
(10) Pub. No.: US 2010/0121888 A1
(43) Pub. Date: May 13, 2010

(54) AUTOMATIC DESIGNATION OF FOOTNOTES TO FACT DATA

(75) Inventors: Jeffrey B. Cutting, Aurora, CO (US); Michael A. Bush, Highlands Ranch, CO (US); Angela C. Selman, Highlands Ranch, CO (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/268,584

(22) Filed: Nov. 11, 2008

(51) Int. Cl. G06F 17/30; G06F 7/00

(52) U.S. Cl. 707/803; 707/E17.045

(57) ABSTRACT

Architecture where footnotes can be tied directly to fact data on a line-by-line basis, for example, and presented to a consumer of the data in a desired language. A reporter mechanism is provided for associating footnotes to fact data at report preparation time. Using a report/building block metaphor, the architecture provides the ability to tie footnotes to one or many fact data. In the context of financial data, building blocks are rows (which usually define account information), columns (which usually define book codes and reporting periods) and optional trees (which define departmental structure for a report). Once the footnote or multiple footnotes are associated with a building block or logical operations on building blocks (e.g., intersection), the footnotes are also auto-generated for each report, and at the desired block locations. Moreover, the user can select one or more languages in which to present the footnotes.

### BACKGROUND

Footnotes are an important part of reporting systems such as for issuing financial statements. Financial statement preparers have traditionally produced financial statement footnotes out of synchronism with the rest of the financial statement. That is, the statements are prepared and then the preparer has to retroactively prepare and insert the footnotes, oftentimes far after the statements are prepared and oftentimes using a separate software application.

Moreover, report generation typically occurs in a single language as do the footnotes. Thus, for a corporation with an international presence, the financial statements may need to be provided in multiple languages as well as the footnotes. This results in the expenditure of additional resources in terms of personnel and systems to provide such reports. In one example, this can be particularly important where compliance is an issue such as for Sarbanes-Oxley compliance and for foreign filings that need to be provided in different languages.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes functionality where footnotes are tied directly to fact data on a line-by-line basis, for example, and presented to a consumer of the data in the desired selected language. The architecture includes a reporter as a mechanism for easily associating footnotes to data (e.g., financial) at report preparation time. Using a report/building block metaphor, the architecture provides the ability to tie footnotes to one or many fact data. Building blocks are combined to produce reports.

In the context of business data such as financial data, building blocks are rows (which usually define account information), columns (which usually define book codes and reporting periods) and optional trees (which define departmental structure for a report). When the building blocks are selected within a report definition, the user has the ability to define footnotes and relate the footnotes to specific row(s), column(s), and optionally, tree intersections. When the report is generated, these intersections equate to specific data facts. Once the footnote or multiple footnotes are associated with a building block or logical operations on building blocks (e.g., intersection), the footnotes are also auto-generated for each report, and at the desired block locations. Moreover, the user can select one or more languages in which to present the footnotes.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented reporting system for inserting footnotes into a report.

FIG. 2 illustrates a more detailed embodiment of a reporting system for associating footnotes with fact data of the report.

FIG. 3 illustrates a reporting system that allows the user to present footnotes in one or more languages.

FIG. 4 illustrates a simplified diagram of example types of building block, footnote, and language associations that can be made in accordance with the disclosed architecture.

FIG. 5 illustrates screenshots of footnote dialogs presented for footnote processing.

FIG. 6 illustrates the association of a footnote with row building block.

FIG. 7 illustrates the association of a footnote with column building block.

FIG. 8 illustrates a reporting unit selection dialog that facilitates assignment of a footnote to a tree branch.

FIG. 9 illustrates a sample main footnotes dialog presented when all of the references are established.

FIG. 10 illustrates a computer-implemented method of applying footnotes to data.

FIG. 11 illustrates a method of converting the footnote into one or more languages.

FIG. 12 illustrates a method of associating a footnote with fact data.

FIG. 13 illustrates an alternative method of associating a footnote with fact data.

FIG. 14 illustrates a method of applying a footnote to a tree building block.

FIG. 15 illustrates a block diagram of a computing system operable to provide footnote assignments in accordance with the disclosed architecture.

### DETAILED DESCRIPTION

The disclosed architecture includes a reporter as a mechanism for easily associating footnotes to data (e.g., financial) at report preparation time. Using a report/building block metaphor, the architecture provides the ability to tie footnotes to one or many fact data. Fact data is intended to mean the resulting data generated by processing all basis data initially input into computation to produce the final output report. In other words, the fact data is the data presented in the final report, whereas the basis data is that which is processed to generate the fact data.

The architecture combines building blocks to produce reports. In the context of business data such as financial data, building blocks are rows (which usually define account information), columns (which usually define book codes and reporting periods) and optional trees (which define departmental structure for a report). When the building blocks are selected within a report definition, the user has the ability to define footnotes and relate the footnotes to specific row(s), column(s), and optionally, tree intersections. When the report is generated, these intersections equate to specific data facts.

In the context of a financial reporting system, the reusable building blocks allow the user to define the financial report only once. The user can then simply repeat the report generation at the desired time (e.g., every month). The user is no longer required to redefine the report for each desired reporting period. The user does not need to define the actual financial facts—only where to get the facts. When the user initiates report regeneration, the architecture dynamically determines what information is to be retrieved, where to get the information, and then retrieves it. Once the footnote or multiple footnotes are associated with a building block or logical operations on building blocks (e.g., intersection), the footnotes are also auto-generated for each report, and at the desired block locations. Moreover, the user can select one or more languages in which to present the footnotes.

The disclosed architecture finds applicability to reporting language taxonomy such as XBRL (extensible business reporting language) for business reporting (e.g., financial statements and disclosures).

This functionality is especially important for Sarbanes-Oxley compliance as the financial facts are tied to footnotes at report generation time, and financial filings can be presented in many languages. The footnotes can be defined for all units of the report or by individual units based on the report definition. Each footnote can be associated with one or many financial facts.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

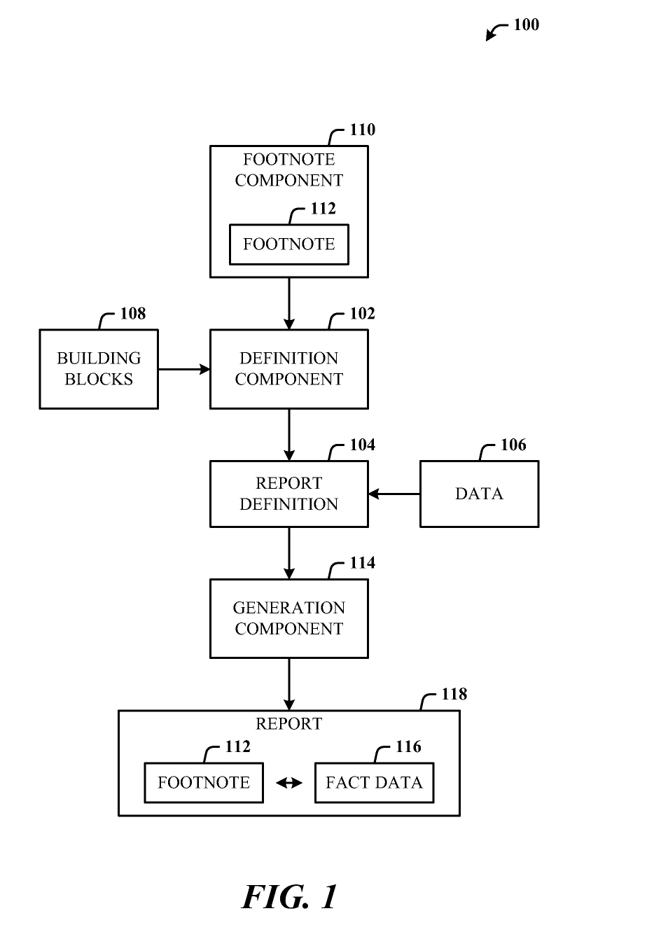

FIG. 1 illustrates a computer-implemented reporting system 100 for inserting footnotes into a report. The system 100 can include a definition component 102 for creating a report definition 104 that defines a relationship between data 106 and building blocks 108. A footnote component 110 can be provided for entering a footnote 112 to be associated with a building block of the building blocks 108. A generation component 114 automatically links the footnote 112 to fact data 116 when an associated report 118 is generated.

The building blocks (e.g., financial, business, etc.) include at least one of row, a column, or a tree (e.g., hierarchical). The footnote 112 is associated and generated with an intersection entity defined by at least two or more of the row, the column, or the tree. In other words, the intersection entity can be associated with a row and a column. When the data 106 associated with the intersection entity is retrieved and processed, this data 106 is processed into the fact data 116. The footnote 112 is dynamically associated and generated with the fact data 116 when the report 118 is generated. The footnote 112 can be dynamically associated and generated with the fact data 116 according to a predetermined periodic time frame such as every week or every month.

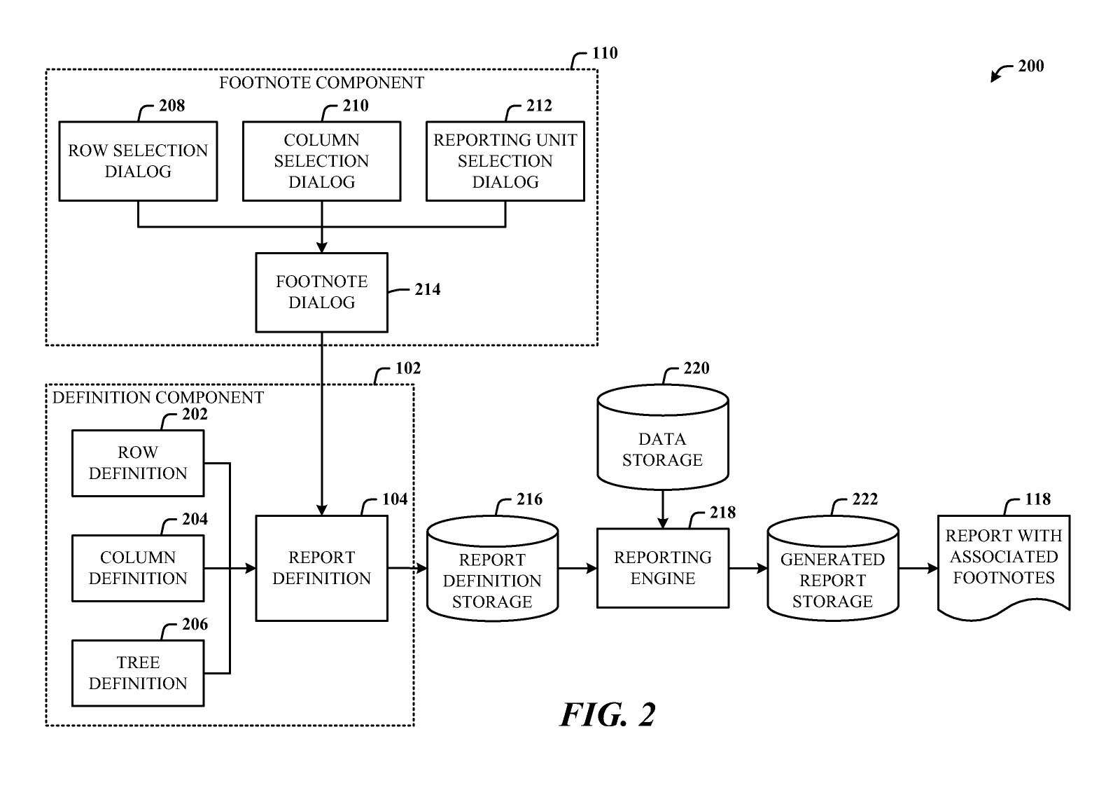

FIG. 2 illustrates a more detailed embodiment of a reporting system 200 for associating footnotes with fact data of the report 118. Here, the definition component is depicted as facilitating creation of the report definition 104 using a row definition 202, a column definition 204, and/or a tree definition 206. Additional input to the report definition 104 can include information from the footnote component 110, depicted here as including several dialogs (user interface (UIs)) a row selection dialog 208, a column selection dialog 210, a reporting unit selection dialog 212 and a footnote dialog 214. The dialogs (208, 210, 212, and 214) are UIs that facilitate the corresponding selection of row(s), column(s), tree branch(es), and creation of a footnote.

Once the report definition 104 has been completed, the report definition 104 can be stored in a report definition storage 216. Multiple different report definitions can be stored in the definition storage 216 such that the user (or automatic mechanisms) can select a report definition via a reporting engine 218, and initiate processing of the selected report definition to output the report 118. The reporting engine 218 processes the selected report definition (e.g., report definition 104), accesses data (e.g., business data such as financials) from a data storage 220, and processes the data into fact data for storage in a generated report storage 222. The report 118 with associated footnotes can then be generated and output.

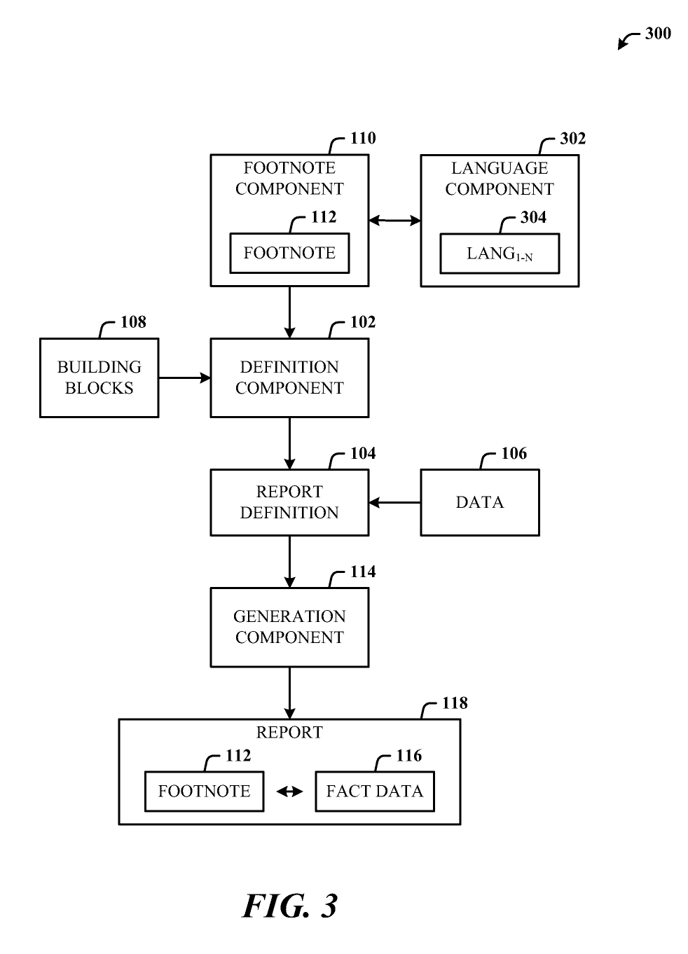

FIG. 3 illustrates a reporting system 300 that allows the user to present footnotes in one or more languages. The system 300 includes the definition component 102 for creating the report definition 104 that is a collection of building blocks 108, location information for obtaining the data 106 for ultimately computing fact data for those building blocks. The footnote component 110 facilitates entry of the footnote 112 to be associated with a building block of the building blocks 108. The generation component 114 automatically links the footnote 112 to fact data 116 when an associated report 118 is generated.

The system 300 further comprises a language component 302 for converting footnotes into the desired language(s) 304 and presenting the footnotes in the selected language(s). The language component 302 provides a language dialog that allows for selection of one or more languages into which the footnote is translated and presented.

In other words, the computer-implemented reporting system, can include the definition component for creating a report definition that includes financial building blocks comprised of rows and columns, the footnote component for creating and associating a footnote with an entity defined by an operation on the building blocks, the language component for selecting a language in which the footnote is presented, and the generation component for automatically linking the footnote to financial fact data associated with the entity when a financial report is generated.

The footnote is dynamically associated and generated with the financial fact data when the financial report is generated. The financial building blocks further include a tree where the footnote is associated with a branch of the tree. The footnote is associated with at least one of the row, the column, the tree, and an intersection of the row and the column. The entity is a cell defined by an intersection operation on the row and the column, and the footnote is automatically associated and presented in association with the entity when the financial report is generated.

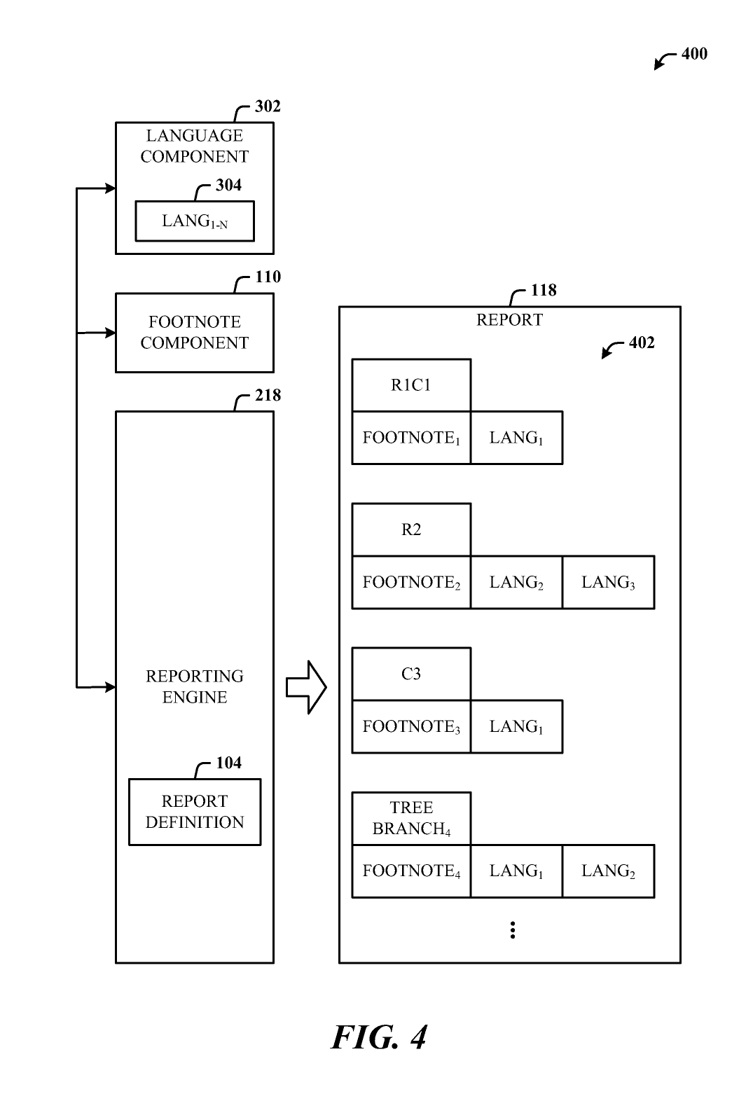

FIG. 4 illustrates a simplified diagram 400 of example types of building block, footnote, and language associations 402 that can be made in accordance with the disclosed architecture. The reporting engine 218 retrieves and processes the report definition 104, which includes the selected building blocks (rows, columns, trees, etc.), language information (language selections for each footnote) from the language component 102 and footnote information (footnote text for each footnote) from the footnote component 110. When the reporting engine 218 retrieves the basis data, footnotes and language information, the report 118 is generated, which can have the following composition: a first footnote (Footnote₁) associated an intersection entity defined by Row 1 (R1) and Column 1 (C1), and a first language (Lang₁). The report 118 can also include a second footnote (Footnote₂) associated with a second row (R2) and translated for presentation in a second language (Lang₂) and a third language (Lang₃). It is also to be understood that the same footnote applied to two different building blocks can be in different languages.

A third footnote (Footnote₃) can be assigned to a third column (C3) and translated into the first language (Lang₃). A fourth footnote (Footnote₄) can be assigned to a fourth branch of a tree (Tree Branch₄) and translated into the first language (Lang₁) and the second language (Lang₂). Other footnotes, translations and assignments can also be made.

Following is a set of screenshots that include UI dialogs presented as part of footnote creation and assignment. The dialogs will be described as applied in a financial context; however, it is to be appreciated that other business contexts can also benefit.

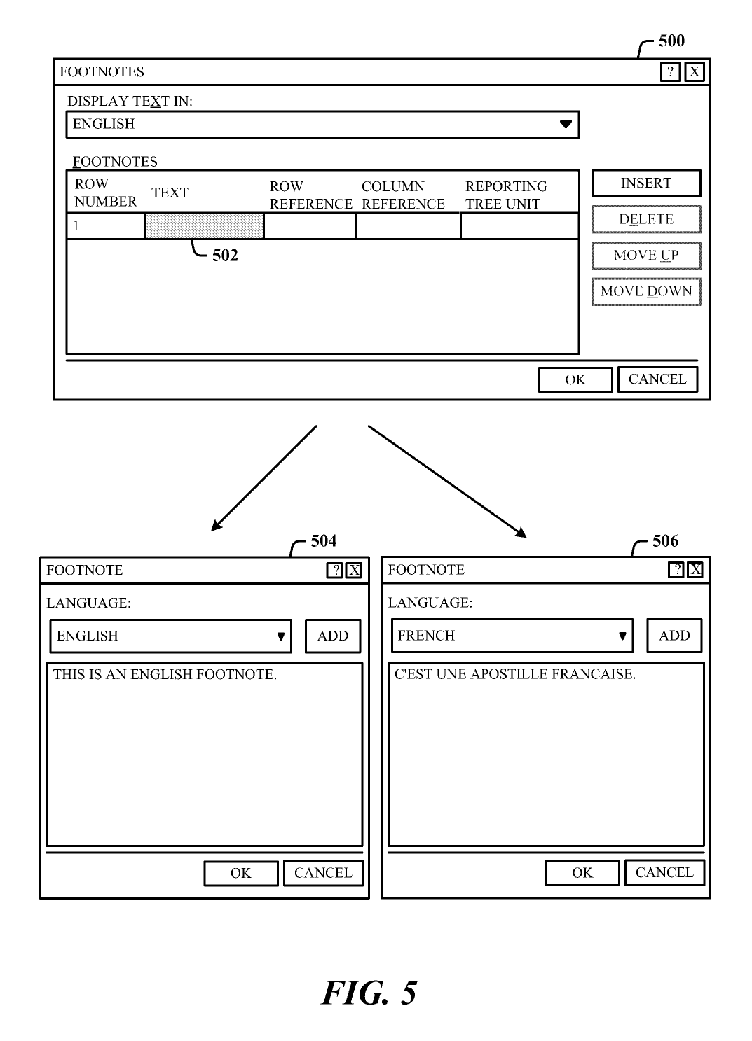

FIG. 5 illustrates screenshots of footnote dialogs. In order to utilize the disclosed functionality, the user configures the report definition to link to the appropriate building blocks and sources of basis data. When the report definition generation occurs, the user can select a Footnotes button and is presented with a main footnotes dialog 500. In response to further selecting a text cell in a row, for example, Text cell 502, the user is presented with an input footnotes dialog 504 to provide the capability to type in multi-line text to describe the financial concept in a textual representation. From the input footnote dialog 504, the user can type in a detailed explanation of the as yet to be associated financial fact(s). In addition, a user can define additional languages into which the footnote is translated. For example, the user can define an English footnote on English (the input footnote dialog 504), and then translate the footnote into French (as illustrated in input footnote dialog 506). Thus, the same footnote information can be presented in the same financial statement (report) in the translated language. The consumer of the footnote can toggle between the languages by simply choosing the appropriate language from a dropdown menu in the dialog presentation.

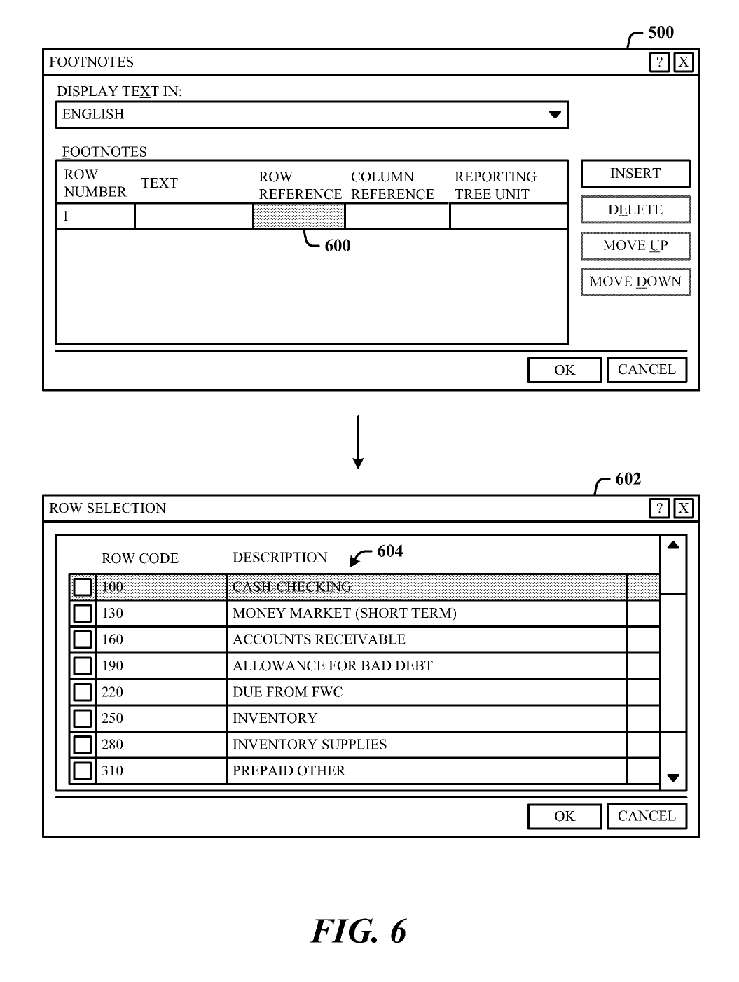

Once the footnote is defined, the user associates the footnote with a row and/or a column from the report definition. FIG. 6 illustrates the association of a footnote with row building block. From the main footnotes dialog 500, on the specified footnote row, the user can select a Row Reference column 600 to launch a Row Selection dialog 602. From this dialog, the user can associate the note directly with one to many financial rows 604 by selecting the checkbox associated with the row. This results in a footnote which relates directly to the financial information on that row or multiple rows.

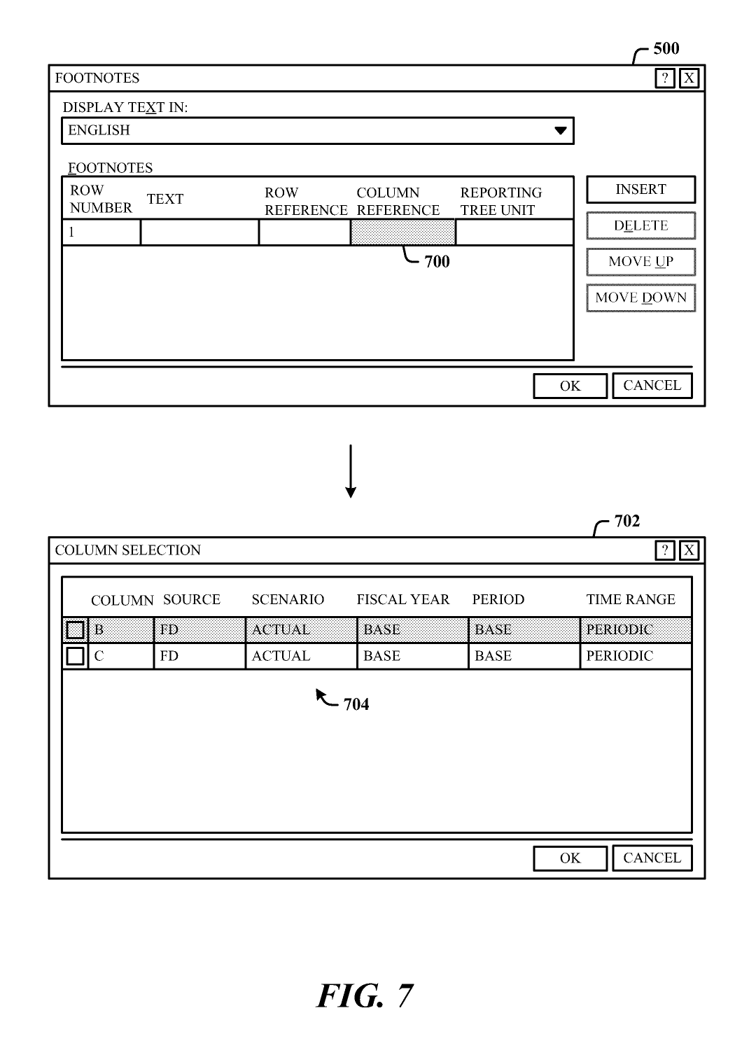

A user can then associate the footnote with a column. FIG. 7 illustrates the association of a footnote with column building block. To accomplish this task, the user selects a Column Reference column 700 to launch a Column Selection dialog 702 from the main footnotes dialog 500 on the specified footnote row. From the Column Selection dialog 702, the user can associate the footnote directly with one or many column definitions by selecting the checkboxes associated with the columns 704. This results in a footnote which relates directly to the financial information for that period or many periods.

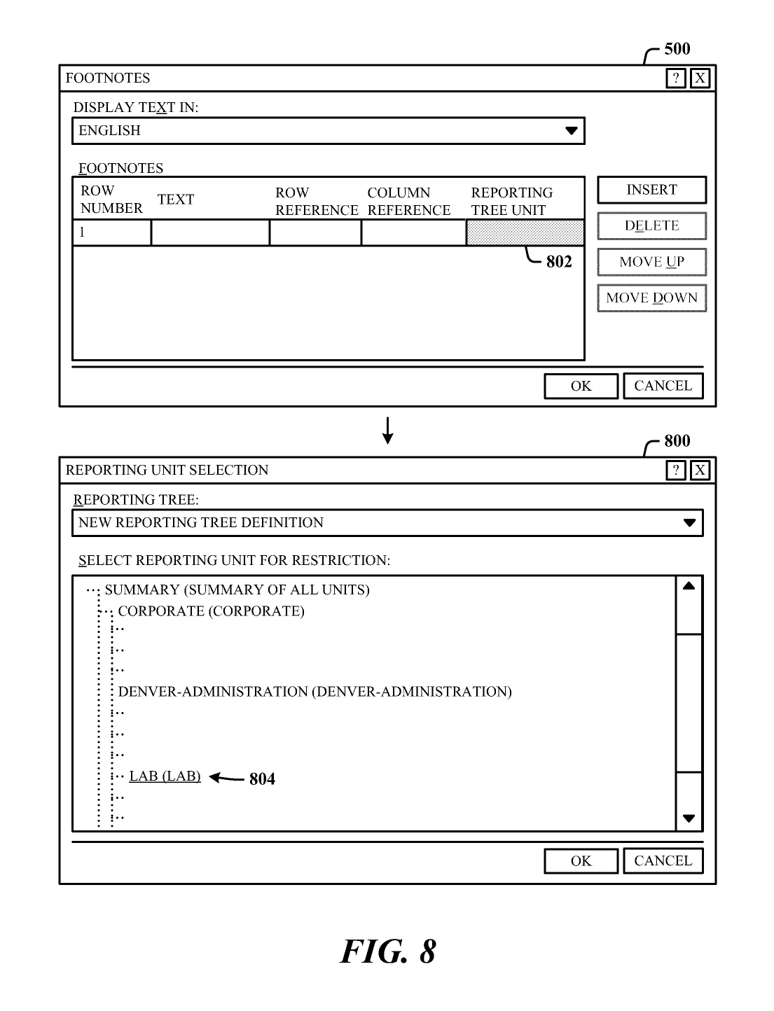

Optionally, the user can associate the footnote with a branch of a tree. FIG. 8 illustrates a reporting unit selection dialog 800 that facilitates assignment of a footnote to a tree branch. This can mean, generally, that the footnote is associated with a specific division or department. To accomplish this task, the user selects in the Reporting Tree Reference column 802 on the specified footnote row of the main footnotes dialog 500 to launch the reporting unit selection dialog 800. From the reporting unit selection dialog 800, the user can associate the footnote directly with one unit (branch) 804 of the tree by selecting the unit in the tree structure presented to the user. This will result in a footnote that relates directly to the financial information for division or department.

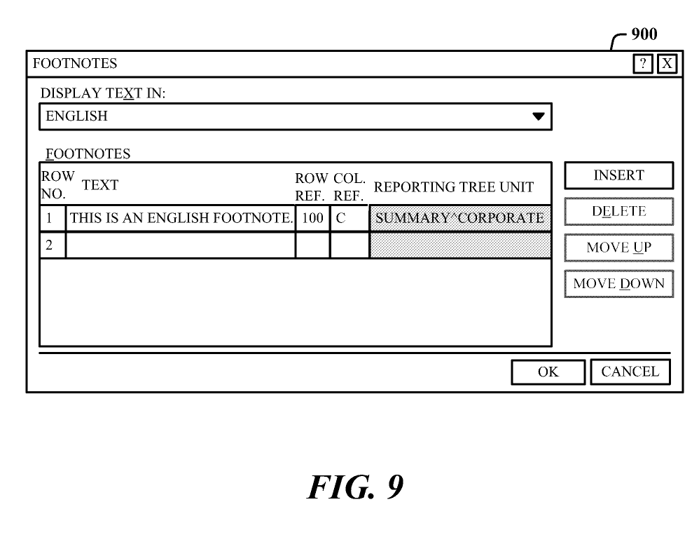

FIG. 9 illustrates a sample main footnotes dialog 900 presented when all of the references are established. In other words, the cells of the main footnotes dialog 500 of FIG. 5 are now filled in with desired information. Thus, when the report (financial statement) is generated, a footnote indicates “This is an English footnote”, which is now associated with row 100, column C for the Corporate reporting unit of the Denver-Administration in the report. All of these mechanisms can narrow the scope of the footnote to a specific row, column, cell, and branch of financial data.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

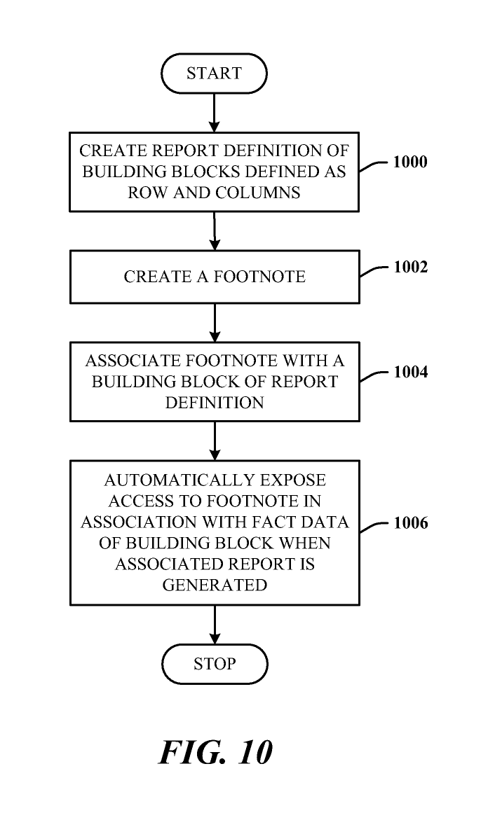

FIG. 10 illustrates a computer-implemented method of applying footnotes to data. At 1000, a report definition of building blocks is created, where the building blocks are defined as rows and columns. At 1002, a footnote is created. This is facilitated using a footnote dialog UI. At 1004, the footnote is associated with a building block of the report definition. In other words, the footnote can be associated with a single building block such as a row or a column, and/or ultimately, the intersection of a row and a column, the intersection defining an intersection entity via which fact data is presented. At 1006, access to the footnote is automatically exposed in association with the fact data of the building block when a report is generated. The report generation process merges information from several sources into the final report where data retrieved and processed is used to generate the fact data for the intersection entity. Where the footnote is associated with a column, no fact data may actually be involved. The footnote will then be exposed at some point in the column such as the column header nomenclature, or at the last entity under the column, for example.

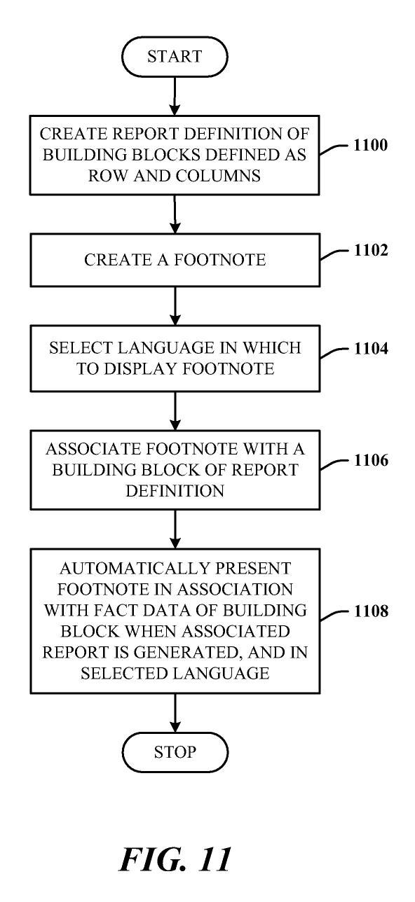

FIG. 11 illustrates a method of converting the footnote into one or more languages. At 1100, a report definition of building blocks is created, where the building blocks are defined as rows and columns. At 1102, a footnote is created. At 1104, a language dialog UI is presented that allows the user to convert the footnote into one or more languages, and present the footnote in the languages. At 1106, the footnote is associated with a building block of the report definition. At 1108, access to the footnote is automatically exposed in association with the fact data of the building block when a report is generated. The report generation process merges information from several sources into the final report where data retrieved and processed is used to generate the fact data for the associated building block(s).

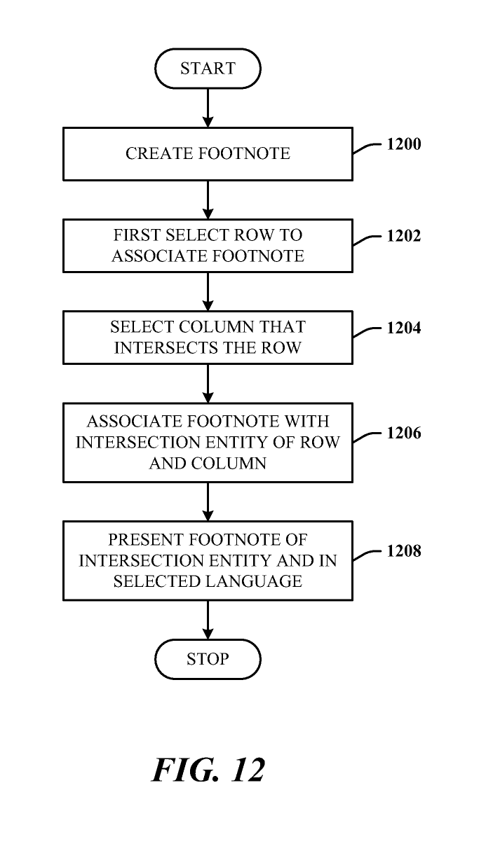

FIG. 12 illustrates a method of associating a footnote with fact data. At 1200, the user creates the footnote via a footnote dialog. At 1202, a row dialog UI is presented via which the user can select a row to which the footnote is associated. At 1204, a column dialog UI is presented via which the user can select a column that intersects the row. At 1206, the user associates the footnote with the intersection entity defined by the intersection of the row and the column. At 1208, the footnote is presented at the intersection entity, and in a selected language.

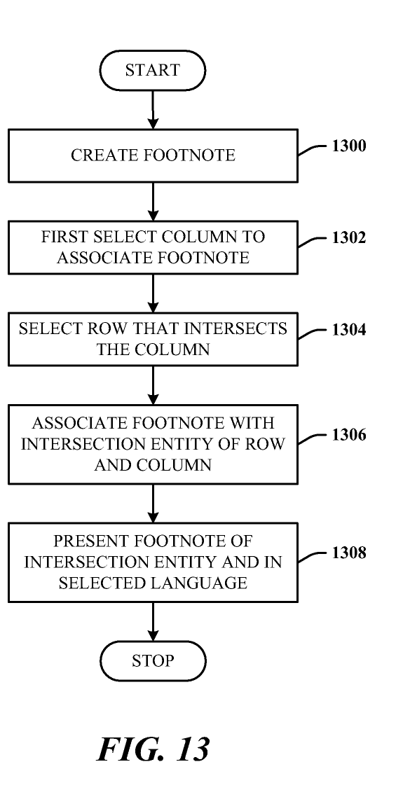

FIG. 13 illustrates an alternative method of associating a footnote with fact data. At 1300, the user creates the footnote via a footnote dialog. At 1302, a column dialog UI is presented via which the user can select a column to which the footnote is associated. At 1304, a row dialog UI is presented via which the user can select a row that intersects the previously-selected column. At 1306, the user associates the footnote with the intersection entity defined by the intersection of the column and the row. At 1308, the footnote is presented at the intersection entity, and in a selected language.

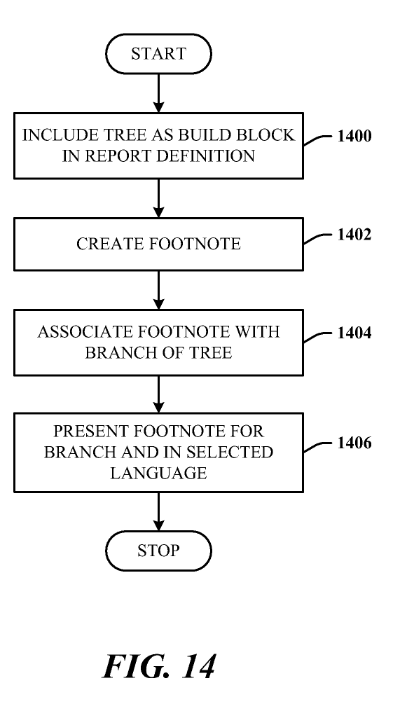

FIG. 14 illustrates a method of applying a footnote to a tree building block. At 1400, a tree building block is included in the report definition. At 1402, a footnote is created via a footnote dialog UI. At 1404, the footnote is associated with a branch of the tree. At 1406, the footnote is presented at the branch entity, and in a selected language.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

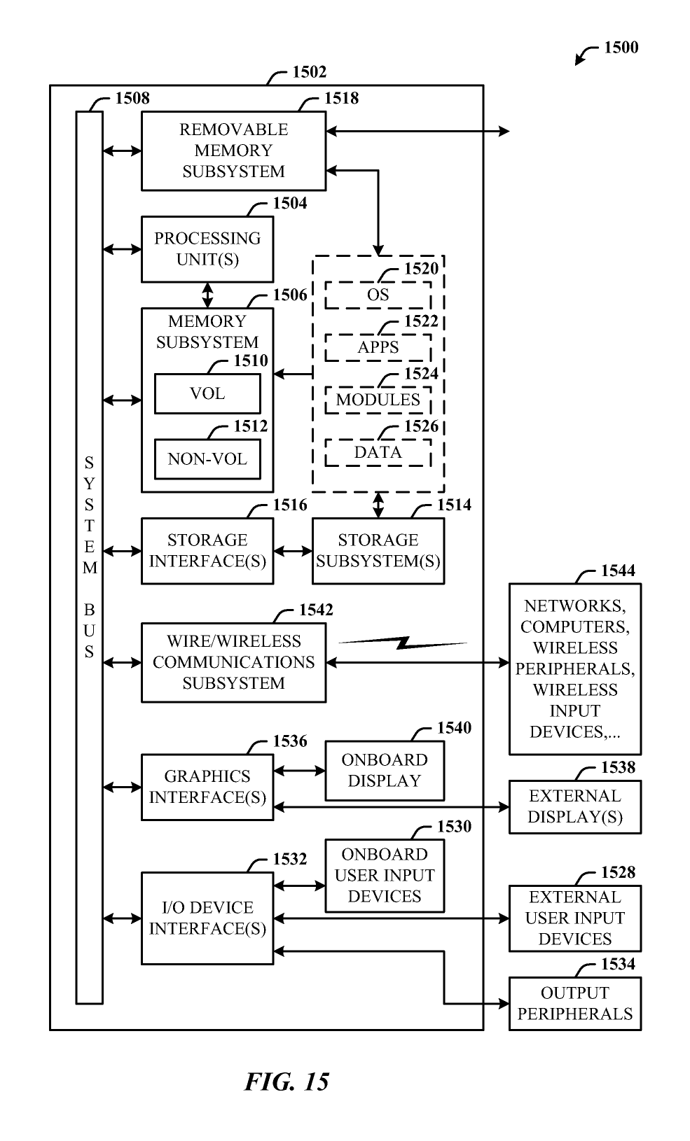

Referring now to FIG. 15, there is illustrated a block diagram of a computing system 1500 operable to provide footnote assignments in accordance with the disclosed architecture. In order to provide additional context for various aspects thereof, FIG. 15 and the following discussion are intended to provide a brief, general description of the suitable computing system 1500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1500 for implementing various aspects includes the computer 1502 having processing unit(s) 1504, a system memory 1506, and a system bus 1508. The processing unit(s) 1504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1506 can include volatile (VOL) memory 1510 (e.g., random access memory (RAM)) and non-volatile memory (NON-VOL) 1512 (e.g., ROM, EPROM, EEPROM, etc.). A basic input/output system (BIOS) can be stored in the non-volatile memory 1512, and includes the basic routines that facilitate the communication of data and signals between components within the computer 1502, such as during startup. The volatile memory 1510 can also include a high-speed RAM such as static RAM for caching data.

The system bus 1508 provides an interface for system components including, but not limited to, the memory subsystem 1506 to the processing unit(s) 1504. The system bus 1508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1502 further includes storage subsystem(s) 1514 and storage interface(s) 1516 for interfacing the storage subsystem(s) 1514 to the system bus 1508 and other desired computer components. The storage subsystem(s) 1514 can include one or more of a hard disk drive (HDD), a magnetic floppy disk drive (FDD), and/or optical disk storage drive (e.g., a CD-ROM drive DVD drive), for example. The storage interface(s) 1516 can include interface technologies such as EIDE, ATA, SATA, and IEEE 1394, for example.

One or more programs and data can be stored in the memory subsystem 1506, a removable memory subsystem 1518 (e.g., flash drive form factor technology), and/or the storage subsystem(s) 1514, including an operating system 1520, one or more application programs 1522, other program modules 1524, and program data 1526. Generally, programs include routines, methods, data structures, other software components, etc., that perform particular tasks or implement particular abstract data types. The one or more application programs 1522, other program modules 1524, and program data 1526 can include some or all of the items of the system 100 of FIG. 1, the system 200 of FIG. 2, the system 300 of FIG. 3, the diagram 400 of FIG. 4, the screenshots of dialogs of FIGS. 5-9, and the methods of FIGS. 10-14, for example.

All or portions of the operating system 1520, applications 1522, modules 1524, and/or data 1526 can also be cached in memory such as the volatile memory 1510, for example. It is to be appreciated that the disclosed architecture can be implemented with various commercially available operating systems or combinations of operating systems (e.g., as virtual machines).

The storage subsystem(s) 1514 and memory subsystems (1506 and 1518) serve as computer readable media for volatile and non-volatile storage of data, data structures, computer-executable instructions, and so forth. Computer readable media can be any available media that can be accessed by the computer 1502 and includes volatile and non-volatile media, removable and non-removable media. For the computer 1502, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1502, programs, and data using external user input devices 1528 such as a keyboard and a mouse. Other external user input devices 1528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1502, programs, and data using onboard user input devices 1530 such a touchpad, microphone, keyboard, etc., where the computer 1502 is a portable computer, for example. These and other input devices are connected to the processing unit(s) 1504 through input/output (I/O) device interface(s) 1532 via the system bus 1508, but can be connected by other interfaces such as a parallel port, IEEE 1394 serial port, a game port, a USB port, an IR interface, etc. The I/O device interface(s) 1532 also facilitate the use of output peripherals 1534 such as printers, audio devices, camera devices, and so on, such as a sound card and/or onboard audio processing capability.

One or more graphics interface(s) 1536 (also commonly referred to as a graphics processing unit (GPU)) provide graphics and video signals between the computer 1502 and external display(s) 1538 (e.g., LCD, plasma) and/or onboard displays 1540 (e.g., for portable computer). The graphics interface(s) 1536 can also be manufactured as part of the computer system board.

The computer 1502 can operate in a networked environment (e.g., IP) using logical connections via a wire/wireless communications subsystem 1542 to one or more networks and/or other computers. The other computers can include workstations, servers, routers, personal computers, microprocessor-based entertainment appliance, a peer device or other common network node, and typically include many or all of the elements described relative to the computer 1502. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1502 connects to the network via a wire/wireless communication subsystem 1542 (e.g., a network interface adapter, onboard transceiver subsystem, etc.) to communicate with wire/wireless networks, wire/wireless printers, wire/wireless input devices 1544, and so on. The computer 1502 can include a modem or has other means for establishing communications over the network. In a networked environment, programs and data relative to the computer 1502 can be stored in the remote memory/storage device, as is associated with a distributed system. It will be appreciated that the network connections shown are exemplary and other means of establishing a communications link between the computers can be used.

The computer 1502 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented reporting system, comprising:
a definition component for creating a report definition that defines a relationship between data and building blocks;
a footnote component for entering a footnote associated with a building block; and
a generation component for automatically linking the footnote to fact data when an associated report is generated.

2. The system of claim 1, wherein the financial building blocks include at least one of row, a column, or a tree.

3. The system of claim 2, wherein the footnote is associated and generated with an intersection of at least two or more of the row, the column, or the tree.

4. The system of claim 1, wherein the footnote is dynamically associated and generated with the financial fact data when the report is generated.

5. The system of claim 1, wherein the footnote is dynamically associated and generated with the financial fact data according to a predetermined periodic time frame.

6. The system of claim 1, further comprising a language component for converting and presenting the footnotes in a selected language.

7. The system of claim 1, wherein the footnote is associated with multiple building blocks.

8. The system of claim 1, wherein the data is financial data, the building blocks are associated with the financial data, and the report is a financial report that exposes footnotes associated with financial fact data.

9. A computer-implemented reporting system, comprising:
a definition component for creating a report definition that includes financial building blocks comprised of rows and columns;
a footnote component for creating and associating a footnote with an entity defined by an operation on the building blocks;
a language component for selecting a language in which the footnote is presented; and
a generation component for automatically linking the footnote to financial fact data associated with the entity when a financial report is generated.

10. The system of claim 9, wherein the footnote is dynamically associated and generated with the financial fact data when the financial report is generated.

11. The system of claim 9, wherein the financial building blocks further include a tree where the footnote is associated with a branch of the tree.

12. The system of claim 11, wherein the footnote is associated with at least one of the row, the column, the tree, or an intersection of the row and the column.

13. The system of claim 9, wherein the entity is a cell defined by an intersection operation on the row and the column, and the footnote is automatically associated and presented in association with the entity when the financial report is generated.

14. A computer-implemented method of applying footnotes to data, comprising:
creating a report definition of building blocks defined as rows and columns;
creating a footnote;
associating the footnote with a building block of the report definition; and
automatically exposing access to the footnote in association with fact data of the building block when a report is generated.

15. The method of claim 14, further comprising selecting a language in which to display the footnote.

16. The method of claim 14, further comprising associating the footnote first with a row, and then selecting a column, the intersection of which defines an intersection entity to which the footnote is associated.

17. The method of claim 14, further comprising associating the footnote first with a column, and then selecting a row, the intersection of which defines an intersection entity to which the footnote is associated.

18. The method of claim 14, further comprising including a tree as a building block in the report definition.

19. The method of claim 18, further comprising associating the footnote with a branch of the tree.

20. The method of claim 14, further comprising associating the footnote with multiple rows or multiple columns.
